(19) United States
(12) Patent Application Publication
(10) Pub. No.: US 2003/0021981 A1
(43) Pub. Date: Jan. 30, 2003

(54) Colored polyolefin film and method of making

(76) Inventors: Pang-Chia Lu, Pittsford, NY (US); Robert M. Sheppard, Victor, NY (US); Donald J. Burns, Fairport, NY (US); Robert A. Migliorini, North haven, CT (US); Sal J. Pellingra, Wolcott, NY (US); Karen Ann Sheppard, Victor, NY (US); Robert Guthrie Peet, Pittsford, NY (US)

Correspondence Address: ExxonMobil Chemical Company, P.O. Box 2149, Baytown, TX, 77522, US

(21) Appl. No.: 09/757,175

(22) Filed: Jan. 9, 2001

(51) Int. Cl. B32B 5/22

(52) U.S. Cl. 428/317.9; 428/319.7; 428/319.9

(57) ABSTRACT

A multi-layered colored thermoplastic film comprising an opaque core layer comprising a thermoplastic material and a first skin layer comprising a thermoplastic material with a coloring agent adjacent to the core layer, and a method producing same.

### RELATED APPLICATIONS

This application is a continuation-in-part of application Ser. No. to be assigned (ExxonMobil Docket No. 10234, inventors: Pang-Chia Lu, Robert Sheppard, Don Bums, RObert Migliorini, Sal Pellingra, Karen Sheppard, Robert Peet)), filed Dec. 19, 2000, entitled “Colored Polyolefin Film and Method of Making,” the entire disclosure of which is hereby incorporated herein by reference.

### BACKGROUND OF THE INVENTION

The present invention relates to coextruded films made of multiple layers of thermoplastics, wherein at least one of the layers is colored using a coloring agent, and at least one of the remaining layers is opaque.

In the packaging of certain types of foods, such as snack foods like potato chips, cookies and the like, it is common practice to employ a multi-layer film. A desirable property in such a packaging film is an opacity which protects the packaged product from deterioration caused by exposure to light. In particular, it has been found that certain wavelengths of light, up to about 450 nm cause increased spoilage in such packaged products. Even when a degree of opacity is present in the film, some spoilage may occur depending on how much light may pass through.

Oriented opaque film compositions are known in the art. U.S. Pat. No. 4,377,616 discloses an opaque, biaxially oriented polymeric film structure of lustrous satin appearance comprising a thermoplastic core matrix having a strata of voids; said voids being created by the inclusion within the matrix material of spherical void-initiating solid particles which are incompatible with the matrix material. The void space occupied by the particle is substantially less than the volume of the void. The polymer matrix material is extruded in the form of a film and positioned on opposite surfaces of the film are void free, transparent thermoplastic skin layers adhering to said surfaces. The structure has excellent opacity and extremely high gloss measurement and a lustrous satin appearance.

U.S. Pat. No. 4,632,869 discloses a resin combination comprising a thermoplastic polymer matrix having dispersed therein as distinct phases, a multiplicity of small spherical solid particles of polybutylene terephthalate, the resin combination in opaque biaxially oriented polymeric film form and the same oriented film structure having on at least one surface thereof a void-free thermoplastic skin layer. The process for preparing a biaxially oriented opaque film comprising providing said resin combination, forming an unoriented film of said resin combination and biaxially orienting said film to an extent sufficient to opacify the same. The process also provides for the opaque film having a void-free thermoplastic skin layer on at least one surface thereof.

U.S. Pat. No. 5,176,954 also discloses a non-symmetrically layered, highly opaque, biaxially oriented polymer film with a core containing numerous microscopic voids and at least about 1% by weight of opacifying compounds; a first skin layer on one surface of the core containing up to about 12% by weight of inorganic particulate material; and a second skin layer on the other surface of the core.

U.S. Pat. No. 5,397, 635 also a multi-layer opaque, biaxially oriented polymeric film structure. The film structure includes a thermoplastic polymer matrix core layer having a first surface and a second surface, within which is located a strata of voids, positioned at least substantially within a substantial number of the voids is at least one spherical void-initiating particle which is phase distinct and incompatible with the matrix material, the void space occupied by the particle being substantially less than the volume of the void, the population of the voids in the core being such as to cause a significant degree of opacity, a first thermoplastic polymer skin layer having a first surface and a second surface, the first surface of the first skin layer adhering to the first surface of the core layer, the first skin layer including up to about 12% by weight of titanium dioxide contact pigment, and a second thermoplastic polymer skin layer having a first surface and a second surface, the first surface of the second skin layer adhering to the second surface of the core layer, the second skin layer including finely divided, uniformly dispersed inorganic material in an amount effective to impart antiblocking characteristics and decrease the inherent film-to-film coefficient of friction at the second surface of the second thermoplastic polymer skin layer.

U.S. Pat. No. 5,972,490 discloses a biaxially oriented polyolefin films comprising a core layer of propylene polymer, an intermediate layer of a non-voided, substantially non-pigmented propylene polymer on the core layer, and an outer skin layer of a polyolefin including titanium dioxide as a pigment are disclosed.

U.S. Pat. No. 4,758,396 discloses a process for the preparation of a biaxially stretch-oriented film having at least one opaque layer. The opaque layer is composed essentially of propylene polymer and fillers in a quantity of about 10 to 40% by weight, relative to the total weight of propylene polymer and fillers. In production, the granules are melted in a screw extruder, are forced through a die and are formed by cooling to give a preformed film. The preformed film is then stretch-oriented both along the machine direction and transversely perpendicular to the machine direction and is then heat-set. The fillers are added in the form of a masterbatch to the granules of unfilled polymers. The masterbatch should have a filler content of more than about 30% by weight.

U.S. Pat. No. 4,758,462 discloses an opaque, biaxially oriented film structure which comprises: an expanded thermoplastic polymer matrix core layer within which is located a minor amount of a light-absorbing pigment and a strata of voids; positioned at least substantially within at least a substantial number of said voids is at least one void-initiating particle which is phase distinct and incompatible with the matrix material, the void space occupied by said particle being substantially less than the volume of said void, with one generally cross-sectional dimension of said particle, at least approximating a corresponding cross-sectional dimension of said void; the population of voids in said core and the thickness of said core being such as to cause a degree of opacity of less than 15% light transmission; and at least one void-free thermoplastic skin layer affixed to a surface of the core layer, said skin layer(s) being of a thickness such that the outer surfaces thereof do not, at least substantially, manifest the surface irregularities of said core layer.

U.S. Pat. No. 4,652,489 discloses a sealable, opaque polyolefinic multilayer film composed of a polypropylene base layer, a non-sealable surface layer, and a sealable surface layer, and process therefor. The sealable surface layer has a low minimum sealing temperature and is made from a copolymer of propylene and ethylene or butene-1 units and/or a terpolymer of ethylene, propylene and butene-1 units. The non-sealable layer is a combination of a propylene homopolymer and a slip agent. The base layer contains an additive which is incompatible with polypropylene. The process includes stretching of the film, and during the stretching step, the polymer matrix is torn open around the additive particles to form vacuoles which give the base layer a degree of opacity.

U.S. Pat. No. 4,741,950 discloses a surface treated oriented polymer laminate film which possesses a comparatively rough, non-blocking first surface and a smooth, lustrous second surface which is particularly well suited for further film processing operations such as metallization.

U.S. Pat. No. 4,594,211 discloses a thin polyolefine based film, having a thickness of from about 15 to about 200 microns, which is perfectly non-transparent in spite of its low thickness. The film is composed of polyolefine as a homopolymer, an ethylene-vinyl acetate copolymer, and a pigment filler such as titanium dioxide as rutile, and aluminium powder. Color pigments and dispersing agents may also be present. The film is made by extrusion.

Also, in the packaging of certain types of foods, such as snack foods like potato chips, cookies and the like, one or more colors may be printed onto the film packaging. A desirable property in such a packaging film is bright coloring with a pleasing aesthetic appearance.

U.S. Pat. No. 4,894,264 discloses a single-sheet gusset bag for photographic photosensitive materials formed of a laminated sheet comprising a metal foil layer or metallized flexible sheet layer, a water-absorptive, and heat-resistant flexible sheet layer which resists dust formation laminated on the outside of said metal foil layer or metallized flexible sheet layer, and a light-shielding polyolefin resin film layer containing at least linear low density polyethylene resin, carbon black and an antioxidant and having a thickness of more than 50 mu m laminated on the inside of said metal foil layer or metallized flexible sheet layer, and the bottom seal portion is turned or rolled and fixed by an adhesive or adhesive tape.

U.S. Pat. No. 4,536,184 discloses overprinting a poly(vinyl chloride) resin substrate whose surface, or portion thereof, is colored by solvent soluble dye or by way of a mass solvent soluble dye, with a coloring agent made up of a liquid halogenated hydrocarbon solvent having 1-4 carbon atoms, pigment dispersed in said halohydrocarbon solvent, and a film former, dissolved in said halohydrocarbon solvent, consisting essentially of (a) acrylic resin or (b) a combination of acrylic resin and chlorinated polyolefin, at least 50% by weight of acrylic resin; and heat treating said overprinted substrate to adhere said film former and associated pigment.

U.S. Pat. No. 5,683,805 discloses a colored film formed of a transparent film and at least one colored adhesive layer arranged on one side of the transparent film. The adhesive layer has been colored by a colorant composed of a pigment and a dispersant. The dispersant comprises a (meth)acrylate ester polymer formed, as essential monomer components, of an aromatic vinyl monomer, a primary to tertiary amino-containing (meth)acrylate ester monomer and a (meth)acrylate ester monomer containing an ammonium group quatemized with an aromatic compound.

U.S. Pat. No. 5,328,743 discloses a reinforced shrink wrap that has been developed for use in all types of environments and products or applications. The shrink wrap is tear resistant and can be prepared to withstand exposure from the sun and corrosive elements. The wrap is multilayered with reinforcing filamentous grids in adhesive layers on either side of a shrink film with outer layers of olefin film.

U.S. Pat. No. 4,681,803 discloses a pigmented, heat-sealable coating composition for application to a primer-coated, oriented mono-layer or multilayer polyolefin film which comprises a blend of (a) a binding and oxygen barrier effective amount of a heat-sealable polyvinylidene chloride homopolymer and/or polyvinylidene chloride copolymer containing at least about 50 weight percent copolymerized vinylidene chloride, (b) an amount of wax sufficient to result in a significant reduction in the coefficient of friction of a film to which the coating composition is applied and (c) an amount of pigment sufficient to result in a significant reduction in the light transmission property of a film to which the coating composition is applied.

Accordingly, it is an object of the present invention to provide a colored film with low light transmission especially in the UV and blue wavelengths. It is a further object of the present invention to provide a colored film which also has high opacity. It is yet another object of the present invention to provide a colored film which may be bonded to a wide variety of substrates and coatings.

### SUMMARY OF THE INVENTION

The film structure of the present invention is a opaque, biaxially oriented polymeric film with an inner core containing numerous microscopic voids and at least about 1% by weight of void initiating or opacifying compounds and/or particles; a first intermediate layer on one surface of the core layer, containing a coloring agent; a first skin layer on the outside of the first intermediate layer which may or may not contain a coloring agent; a second intermediate layer on the other surface of the core layer and a second skin layer on the outside of the second intermediate layer. The second intermediate layer and/or the second skin layer may or may not contain a coloring agent.

In one family of embodiments, when relatively low concentrations of the coloring agents are used, the film offers a deep and vibrant color. This results from a comparatively large portion of the incident light reaching the opaque inner core where it is reflected or refracted back through the first intermediate layer containing a coloring agent; without too much scattering. The film typically offers good protection against light going through the film, with an opacity greater than 60%, and light transmission less than 40% in the wavelength range of from 250 nm to 500 nm which is particularly damaging to a packaged food product.

The configuration of the layers offers great flexibility and economy in achieving desired film characteristics. The first intermediate and skin layers which may be on a package exterior allow optimum protection against water vapor transmission and a vibrantly colored surface which can be printed, laminated or otherwise modified. The inner core layer has all the advantages of cavitation with protection against light transmission. The second intermediate layer can also be colored the same or a different color for a film with the same or different colors on each side. The second skin layer can be a simple, economical thin encapsulating layer or it can be a more elaborate heat sealable layer.

The composition of the layers can allow for a differential appearance when viewed from the first skin layer or when viewed from the second skin layer. A first color will be viewed on the first skin layer together with any printing or other modifications. A second color can be viewed on the second skin layer together with different printing or modifications, or the appearance from the second skin layer can be a plain white which would be suitable for the inside of a food package.

For a better understanding of the present invention, together with other and further objects, reference is made to the following description, taken together with the accompanying drawings, and its scope will be pointed out in the appended claims.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of several illustrative embodiments when read in conjunction with the accompanying drawings, wherein:

FIG. 1 is a schematic diagram of a method for determining percent light transmission;

FIG. 2 is a schematic diagram of a method for determining percent opacity;

FIG. 3 is a cross sectional view of a five layered colored film;

FIG. 4 is a cross sectional view of a three layered colored film;

FIG. 5 is a cross sectional view of a four layered colored film; and

FIG. 6 is a cross sectional view of a two layered colored film.

### DETAILED DESCRIPTION OF THE DRAWINGS

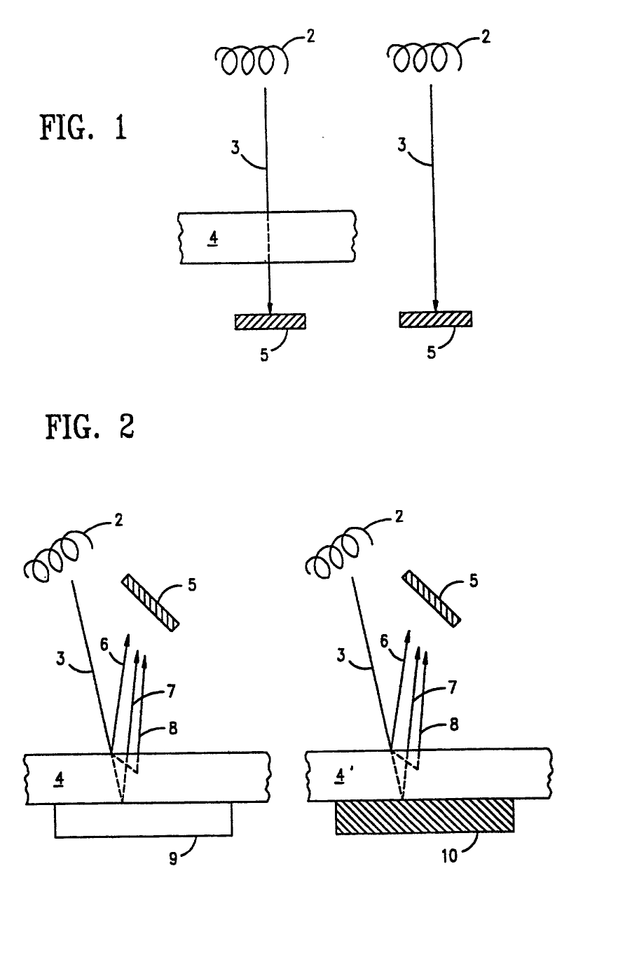

FIG. 1, shows how the percent light transmission through a film is determined by using light source 2 to transmit light rays 3 directly through film 4 and measuring at light sensor 5, value T₂ which is the amount of light rays 3 which is transmitted through film 4. The amount of light rays 3 which can be directly transmitted, value T₁, is determined by measuring the light rays 3 directly transmitted by light source 2 with no intervening film. The percent light transmission through the film can then be determined using the formula:

% Light Transmission=T₂/T₁*100

Referring now to FIG. 2, for a measure of percent opacity of a film, light source 2 transmits light rays 3 through film 4 onto a white surface 9 and the same procedure used to project light onto a black surface 10. With both white and black surfaces, measurement at light sensor 5 is of all of the following: light reflected off the upper surface of the film 6; light transmitted through the film and reflected by the white surface 9 or black surfaces 10 on the side of the film opposite from the light source 7; and, light scattered by the film 8.

The percent opacity of the film can then be determined using the formula:

% Opacity=100*R_{B}/R_{W}

where

R_{W}=Reflected light+scattered light+light transmitted through the film and reflected off a white surface

R_{B}=Reflected light+scattered light+light transmitted through the film and reflected off a black surface

Accordingly, a highly reflective film may provide high opacity while allowing light transmission. This is because percent light transmission is not the equivalent of percent opacity.

Light transmission is the amount of light passing directly through the film. To prevent food spoilage decreased light transmission is desirable. Prevention of light transmission in shorter UV wavelengths up to 400 nm and the blue-violet range of from 400 to 450 nm is particularly desirable for this purpose.

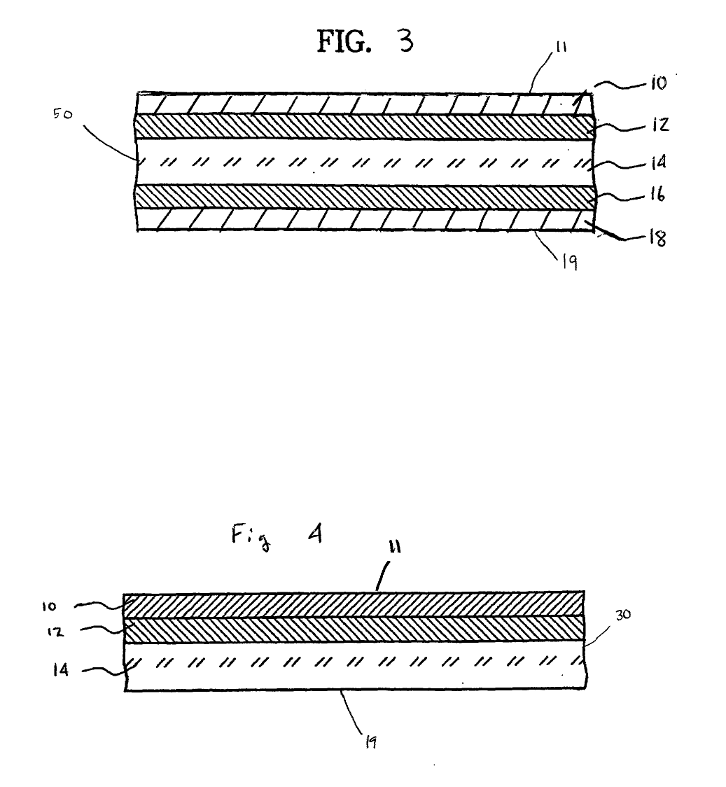

Referring now to FIG. 3 is a cross sectional view of a five layered colored film 50. The film 50 is comprised of a first surface 11, a first skin layer 10, a first intermediate or transition layer 12, an opaque core layer 14, a second intermediate or transition layer 16, a second skin layer 18, and a second surface 19.

In one embodiment of a five layered film 50, the first skin layer 10 and/or the first transition layer 12 can be colored by a coloring agent. The percent light transmission of the combination of the first skin layer 10 and the first transition layer 12 is relatively high, in one embodiment from 50-99%, in another embodiment from 65-97% and in a third embodiment from 75-95%. Additionally the percent opacity of the combination of the first skin layer 10 and the first transition layer 12 is relatively low, in one embodiment from 1-50%, in another embodiment from 3-40% and in a third embodiment from 5-25%. This combination of low opacity and high light transmission allows the light to enter the first surface 11 travel through the first skin layer 10 and the first transition layer 12 and reach the opaque core layer 14 from where it is reflected and travels back through the first transition layer 12 and the first skin layer 10 to reach the first surface 11 and provide for deep and vibrant color. In this embodiment, the percent light transmission of the film 50 is relatively low, in one embodiment from 0-30%, in another embodiment from 0-20% and in a third embodiment from 0-10%. Additionally the percent opacity of the film 50 is relatively high, in one embodiment from 50-100%, in another embodiment from 75-100% and in a third embodiment from 90-100%. This combination of low light transmission and high opacity for the film 50 provides a desirable packaging material which protects the packaged product from deterioration caused by exposure to light.

In a second embodiment, the first skin layer 10 and/or the first transition layer 12 can be colored by a coloring agent as in the first embodiment, and the second skin layer 18 and/or the second transition layer 16 can also be colored by a coloring agent as in the first embodiment. This film 50 allows for one deep and vibrant color to be seen on the first surface 11 and the same or a different deep and vibrant color to be seen on the second surface 19. In this embodiment, the percent light transmission of the film 50 is relatively low, in one embodiment from 0-30%, in another embodiment from 0-20% and in a third embodiment from 0-10%. Additionally the percent opacity of the film 50 is relatively high, in one embodiment from 50-100%, in another embodiment from 75-100% and in a third embodiment from 90-100%. This combination of low light transmission and high opacity for the film 50 provides a desirable packaging material which protects the packaged product from deterioration caused by exposure to light.

In a third embodiment of a five layered film 50, the first skin layer 10 is essentially transparent and the first transition layer 12 is colored by a coloring agent. Additionally, the first surface 11 on top of the first skin layer 10 an image is printed. The percent light transmission of the first transition layer 12 is relatively high, in one embodiment from 50-99%, in another embodiment from 65-90% and in a third embodiment from 75-85%. Additionally the percent opacity of the first transition layer 12 is relatively low, in one embodiment from 1-50%, in another embodiment from 5-40% and in a third embodiment from 10-25%. This combination of low opacity and high light transmission allows the light to enter the first surface 11 travel through the first skin layer 10 and the first transition layer 12 and reach the opaque core layer 14 from where it is reflected and travels back through the first transition layer 12 and the first skin layer 10 to reach the first surface 11 and provide for deep and vibrant color and produces a 3-D effect which makes the printed image appear to float on top of the film 50. In this embodiment, the percent light transmission of the film 50 is relatively low, in one embodiment from 0-30%, in another embodiment from 0-20% and in a third embodiment from 0-10%. Additionally the percent opacity of the film 50 is relatively high, in one embodiment from 50-100%, in another embodiment from 75-100% and in a third embodiment from 90-100%. This combination of low light transmission and high opacity for the film 50 provides a desirable packaging material which protects the packaged product from deterioration caused by exposure to light. One variation of the third embodiment has a printed image on the first surface 11, a first skin layer 10 made of polyethylene, a first transition layer 12 made of a colored polypropylene, a core layer 14 made of cavitated polypropylene, a second transition layer 16 made of polypropylene, and a second skin layer 18 made of polypropylene.

In a fourth embodiment of a five layered film 50, inorganic additives are added to the first skin layer 10 to impart a rough low-gloss paper-like feel to the first surface 11 to simulate kraft paper. The first transition layer 12 is colored by a coloring agent, with a sufficient amount of coloring agent to yield a brown kraft paper color. Additionally, the second skin layer 18 preferably has inorganic additives added to impart a rough low-gloss paper-like feel to the second surface 19 to simulate kraft paper. The second transition layer 16 may be colored by a coloring agent, with a sufficient amount of coloring agent which could be white. One variation of the fourth embodiment has a first surface 11 with a brown coloring and a rough low-gloss paper-like feel and a second surface 19 with a white coloring and a rough low-gloss paper-like feel. In this embodiment, the percent light transmission of the film 50 is relatively low, in one embodiment from 0-30%, in another embodiment from 0-20% and in a third embodiment from 0-10%. Additionally the percent opacity of the film 50 is relatively high, in one embodiment from 50-100%, in another embodiment from 75-100% and in a third embodiment from 90-100%. This combination of low light transmission and high opacity for the film 50 provides a desirable packaging material which protects the packaged product from deterioration caused by exposure to light.

A fifth embodiment has a first skin layer 10 made of an EP impact copolymer or blend of incompatible resins such as PP homopolymer, EP copolymer, EPB terpolymer, HDPE, or LDPE copolymer, and addition of CaCO₃, talc, and SiO₂. In one variation of the fifth, the first skin layer 10 is 0.5 to 3.0 microns thick. The first transition layer 12 is brown colored and made of as PP homopolymer, EP random copolymer, PB copolymer, EPB terpolymer, HDPE, LLDPE, or MDPE with a blend of iron oxide, carbon black, and TiO₂. In another variation, the first transition layer 12 is 1 to 7 microns thick. In a third variation, the core layer 14 is made of an isotactic cavitated polypropylene and is 5 to 50 microns thick. The second transition layer 16 is non-colored (white) and made of as PP homopolymer, EP random copolymer, PB copolymer, EPB terpolymer, HDPE, LLDPE, or MDPE with TiO₂. In another variation, the second transition layer 16 is 1 to 7 microns thick. The second skin layer 18 is made of an EP impact copolymer or blend of incompatible resins such as PP homopolymer, EP copolymer, EPB terpolymer, HDPE, or LDPE copolymer, and the addition of CaCO₃, talc, and/or SiO₂. In another variation, the second skin layer 18 is 0.5 to 3.0 microns thick.

In a sixth embodiment of a five layered film 50, the first skin layer 10 and/or the first intermediate or transition layer 12 can be colored by a coloring agent that absorbs and/or scatters most of the light incident on the film. The percent light transmission of the first skin 10 and the first intermediate or transition 12 layers will be relatively low, in one embodiment from 0-70%, in another embodiment from 0-50%, and in a third embodiment from 0-30%. In the sixth embodiment the percent opacity will be relatively high, in one embodiment from 30-100%, in another embodiment from 50-100%, and in a third embodiment from 70-100%. Very little of the incident light will travel through the layer containing the color agent, reflect off the cavitated core layer, and return through the colored layer back to the observer without being scattered or absorbed. The overall percent light transmission of the film 50 is low, in one embodiment from 0-30%, in another embodiment from 0-20%; and in a third embodiment from 0-10%. The overall opacity of the film 50 is relatively high, in one embodiment from 70-100%, in a second embodiment from 80-100%, and in a third embodiment from 90-100%. This combination of low light transmission and high opacity for the film 50 without the internal reflection of light returning from the cavitated layer back to the observer provides a more restrained or sedate look, typical of a paper-like look or of a color-coated or printed film, and is a desirable packaging material which protects the packaged product from deterioration caused by exposure to light.

In a seventh embodiment of a five layered film 50, the first skin layer 10 and/or the first intermediate or transition layer 12 can be colored by a coloring agent as described in the sixth embodiment, and the second skin layer 18 and/or the second transition or intermediate layer 16 can also be colored by a coloring agent as in the first or sixth embodiment. In this embodiment, most of the light incident on the colored layer or layers having coloring agents which absorb or scatter most of the light incident upon them will be absorbed by the coloring agent. The percent light transmission of such layers will be relatively low, in one embodiment from 0-5 70%, in another embodiment from 0-50%, and in a third embodiment from 0-30%. The percent opacity will be relatively high, in one embodiment from 30-100%, in a second embodiment from 50-100%, and in a third embodiment from 70-100%. Very little of the incident light will travel through the layer or layers containing such a coloring agent, reflect off the cavitated core layer, and return through the colored layer back to the observer without being scattered or absorbed. The overall percent light transmission of the film 50 is low, in one embodiment from 0-30%, in another embodiment from 0-20% and in a third embodiment from 0-10%. The overall opacity of the film opacity of the film 50 is relatively high, in one embodiment from 70- 100%, in another embodiment from 80-100%, and in a third embodiment from 90-100%. This combination of low light transmission and high opacity for the film 50 provides a more restrained or sedate look, typical of a paper-like look or of a color coated or printed film, on one or both sides without the internal reflection of light returning from the cavitated layer back to the observer, and can, alternatively, have the deep and vibrant look on a side selected as described in the first embodiment, and is a desirable packaging material which protects the packaged product from deterioration caused by exposure to light.

Referring now to FIG. 4 is a cross sectional view of a three layered colored film 30. The film 30 is comprised of a first surface 11, a first skin layer 10, a first transition layer 12, an opaque core layer 14, and a second surface 19.

In one embodiment of a three layered film 30, the first skin layer 10 and/or the first transition layer 12 can be colored by a coloring agent. The percent light 30 transmission of the combination of the first skin layer 10 and the first transition layer 12 is relatively high, in one embodiment from 50-99%, in another embodiment from 65-90% and in a third embodiment from 75-85%. Additionally the percent opacity of the combination of the first skin layer 10 and the first transition layer 12 is relatively low, in one embodiment from 1-50%, in another embodiment from 5-40% and in another embodiment from 10-25%. This combination of low opacity and high light transmission allows the light to enter the first surface 11 travel through the first skin layer 10 and the first transition layer 12 and reach the opaque core layer 14 from where it is reflected and travels back through the first transition layer 12 and the first skin layer 10 to reach the first surface 11 and provide for deep and vibrant color. In this embodiment, the percent light transmission of the film 30 is relatively low, in one embodiment from 0-30%, in another embodiment from 0-20% and in a third embodiment from 0-10%. Additionally the percent opacity of the film 30 is relatively high, in one embodiment from 50-100%, in another embodiment from 75-100% and in a third embodiment from 90-100%. This combination of low light transmission and high opacity for the film 30 provides a desirable packaging material which protects the packaged product from deterioration caused by exposure to light.

In a second embodiment of a three layered film 30, the first skin layer 10 is essentially transparent and the first transition layer 12 is colored by a coloring agent. Additionally, the first surface 11 on top of the first skin layer 10 is printed on with an image. The percent light transmission of the first transition layer 12 is relatively high, in one embodiment from 50-99%, in another embodiment from 65-90% and in a third embodiment from 75-85%. Additionally the percent opacity of the first transition layer 12 is relatively low, in one embodiment from 1-50%, in another embodiment from 5-40% and in a third embodiment from 10-25%. This combination of low opacity and high light transmission allows the light to enter the first surface 11 travel through the first skin layer 10 and the first transition layer 12 and reach the opaque core layer 14 from where it is reflected and travels back through the first transition layer 12 and the first skin layer 10 to reach the first surface 11 and provide for deep and vibrant color and make the printed image appear to float on top of the film 30. In this embodiment, the percent light transmission of the film 30 is relatively low, in one embodiment from 0-30%, in another embodiment from 0-20% and in a third embodiment from 0-10%. Additionally the percent opacity of the film 30 is relatively high, in one embodiment from 50-100%, in another embodiment from 75-100% and in a third embodiment from 90-100%. This combination of low light transmission and high opacity for the film 30 provides a desirable packaging material which protects the packaged product from deterioration caused by exposure to light.

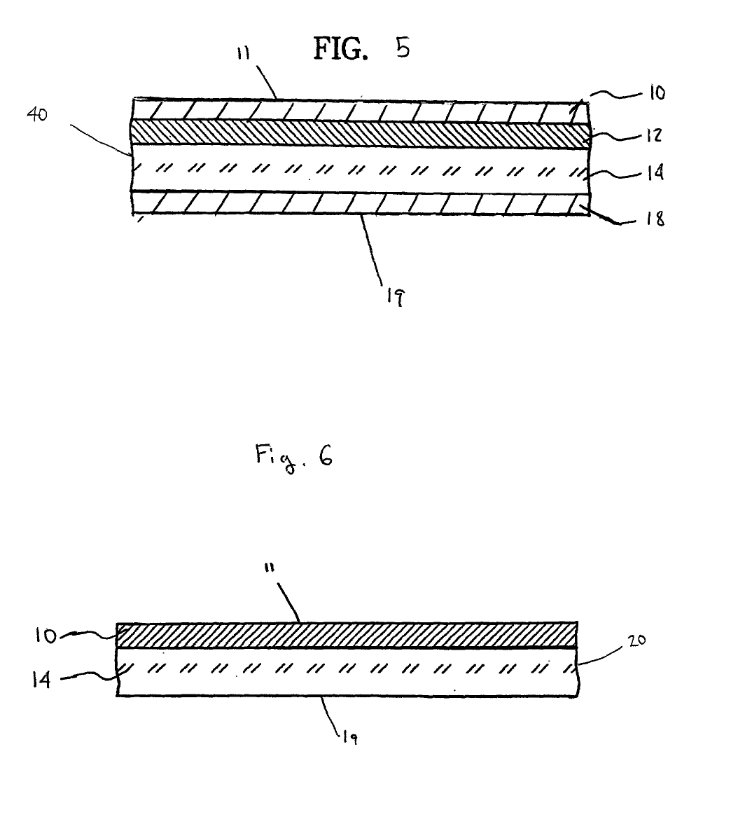

Referring now to FIG. 5 is a cross sectional view of a four layered colored film 40. The film 40 is comprised of a first surface 11, a first skin layer 10, a first transition layer 12, an opaque core layer 14, a second skin layer 18, and a second surface 19.

There are multiple possible embodiments with the four layered colored film 40. The first skin layer 10, the first transition layer 12, and/or the second skin layer 18 can all be colored by a coloring agent to yield a single colored film or a dual colored film as seen on the first surface 11 and the second surface 19. Additionally, the first skin layer 10 and/or the second skin layer 18 can be printed on or treated with inorganic additives to impart a rough low-gloss paper-like feel to the first surface 11 and/or the second surface 19.

Referring now to FIG. 6 is a cross sectional view of a two layered colored film 20. The film 20 is comprised of a first surface 11, a first skin layer 10, an opaque core layer 14, and a second surface 19.

There are multiple possible embodiments with the two layered colored film 20. The first skin layer 10 can be colored by a coloring agent to yield a single colored film as seen on the first surface 11 and the second surface 19. Additionally, the first skin layer 10 can be printed on or treated with inorganic additives to impart a rough low-gloss paper-like feel to the first surface 11.

In one embodiment, the opaque core layer 14 of film 50, film 30, film 40, and film 20 is a thermoplastic polymer matrix material within which is preferably located a stratum of voids. From this it is to be understood that the voids create the matrix configuration. The opacity and low light transmission of the film are preferably enhanced by the addition to the core layer 14 of at least about 1% by weight and up to about 10% by weight of void initiating on opacifying compounds, which are added to the melt mixture of the core layer 14 before extrusion. Opacifying compounds which may be used include iron oxides, carbon black, aluminum, TiO₂, and talc. Although one embodiment has a strata of voids located in the opaque core layer 14, it is possible to form an opaque core layer 14 that is substantially free of voids where the opacity is achieved by the addition of opacifying compounds.

In another embodiment, to aid in providing the film with low light transmission, especially in the UV and blue wavelengths, iron oxide is added to the core layer 14 in an amount of from about 1 to about 8% by weight, or in another embodiment about 2% to 4% by weight. Carbon black or other compounds may also be used. In another embodiment, aluminum is also added in an amount of from about 0 to about 1.0% by weight, in another embodiment from about 0.25% to about 0.75% by weight, and in another embodiment about 0.5% by weight. In another embodiment, the core layer 14 also contains from about 0.5% by weight to about 3% by weight of TiO₂ and/or talc.

In one embodiment, from about 3% to about 9% by weight of inorganic particulate material such as TiO₂ and/or talc is added to the melt mixture of the core layer 14 before extrusion.

As a result of the additions to the first skin layer 10, first transition layer 12, opaque core layer 14, second transition layer 16, and/or second skin layer 18, the film presents a differential appearance. The term “differential” as applied to the film of this invention is intended to convey the concept of the distinctly dissimilar composition and appearance of each exposed film surface: the first surface 11 and the second surface 19. When viewed from the first surface 11, the film can have vibrant coloration, a printed image that appears to float on a colored film, or a kraft paper like finish, a general color-coated or paper-like film appearance, the typical appearance of a film printed with a high opacity ink, or a more restrained or sedate looking appearance. It is contemplated that when the subject film is used in packaging, the second surface 19 is preferably positioned on the interior of a package and the first surface 11 is preferably positioned on the package exterior.

When viewed from the second surface 19, the film can also have a different vibrant coloration, a different printed image that appears to float on a colored film, or a different kraft paper like finish. If the film is being used in packaging, and the second surface 19 is on the interior, then the second surface 19 can be plain white, unprinted and unfinished. But when viewed from the first surface 11, the film presents an excellent printable surface and an appealing appearance desirable for a package exterior.

When viewed from the second surface 19, the film can also have a different vibrant coloration, a different printed image that appears to float on a colored film, or a different kraft paper like finish, a general color-coated or paper-like film appearance, the typical appearance of a film printed with a high opacity ink, or a more restrained or sedate looking appearance.

The film has very high opacity and very low light transmission. A distinction must be made between opacity and light transmission for the purposes of this invention. Opacity is the opposite of transparency and is a function of the scattering and reflection of light transmitted through the film. Opacity is the ability, for example, to block out writing below it.

Through a combination of opacity resulting from cavitation of the core layer 14 and the addition of metal compounds, pigment, and inorganic particulate material, the present invention provides a high opacity, and a low light transmission in the UV range measured at 250 nm and low light transmission in the 450 nm blue range.

In one embodiment, when forming the core layer 14, as in U.S. Pat. Nos. 4,377,616; 4,632,869; 5,176,954; 5,397,635; 5,972,490; 4,758,396; 4,758,462; 4,652,489; 4,741,950; 4,594,211; and 6,004,664 the disclosures of which are incorporated herein by reference in their entirety, a master batch technique can be employed by either forming the void initiating particles in situ or in adding preformed spheres to a molten thermoplastic matrix material. After the formation of a master batch, appropriate dilution of the system can be made by adding additional thermoplastic matrix material until the desired proportions are obtained. However, the components may also be directly mixed and extruded instead of utilizing a master batch method.

The void-initiating particles which are added as filler to the polymer matrix material of the core layer 14 can be any suitable organic or inorganic material which is incompatible with the core material at the temperature of biaxial orientation such as polybutylene terephthalate, nylon, solid or hollow preformed glass spheres, metal beads or spheres, ceramic spheres, calcium carbonate, COC's (cyclic olefin polymers and cyclic olefin copolymers), etc. COC's are described in U.S. Pat. No. 6,048,608 issued to Peet, et al; this patent is incorporated herein by reference in its entirety.

The polyolefin contemplated as the material in the core layer 14 includes polypropylene, polyethylene, polybutene and copolymers and blends thereof. One embodiment uses an isotactic polypropylene containing at least about 80% by weight of isotactic polypropylene, wherein it is preferred that the polypropylene have a melt flow index of from about 2 to 10 g/10 min. Another embodiment uses a high density polyethylene, with a density of 0.95 or greater.

In one embodiment, the average diameter of the void-initiating particles is from about 0.1 to about 10 microns. These particles may be of any desired shape although it is preferred that they be substantially spherical in shape. This does not mean that every void is the same size. It means that, generally speaking, each void tends to be of like shape when like particles are used even though they vary in dimensions. These voids may assume a shape defined by two opposed and edge contacting concave disks.

In one embodiment, characteristics of opacity and appearance are obtained when the two average major void dimensions are greater than about 30 microns.

In another embodiment, the void-initiating particle material, is incompatible with the core material, at least at the temperature of biaxial orientation.

The core layer 14 has been described above as being a thermoplastic polymer matrix material within which is located a stratum of voids. From this it is to be understood that the voids create the matrix configuration. The term “stratum” is intended to convey the understanding that there are many voids creating the matrix. In one embodiment, the voids themselves are oriented so that the two major dimensions are aligned in correspondence with the direction of orientation of the polymeric film structure. After each void has been formed through the initiation of the described particle, the particle generally contributes little else to the system. This is because its refractive index can be close enough to the matrix material that it makes no contribution to opacity. When this is the case, the opacity is principally a function of the light scattering effect which occurs because of the existence of the voids in the system. In another embodiment, iron oxide in an amount of from about 1 to about 8% by wt.; in another embodiment from about 2% to 4%; and in one embodiment aluminum in an amount from about 0 to about 1.0% by wt., in another embodiment from about 0.25% to 0.75% are added to the core matrix. Carbon black or other compounds may also be used in lieu of some or all of the iron oxide.

A typical void of the core is defined as having major dimensions X and Y and minor dimension Z, where dimension X is aligned with machine direction orientation, dimension Y is aligned with transverse direction orientation and dimension Z approximately corresponds to the cross-sectional dimension of the spherical particle which initiated the void.

In one embodiment, the orientation conditions are such that the X and Y dimensions of the voids of the core are major dimensions in comparison to the Z dimension. Thus, while the Z dimension generally approximates the cross-sectional dimension of the spherical particle initiating the void, X and Y dimensions are significantly greater. By way of illustration, room temperature biaxial orientation of a polypropylene matrix containing polybutylene terephthalate (PBT) spheres of the size and amount contemplated herein, would not be effective for this embodiment. Either void splitting would occur, or, voids of insignificant size would result. Polypropylene should be oriented at a temperature significantly higher than its glass transition temperature. The temperature conditions will permit X and Y to be at least several multiples of the Z dimension without void splitting at least to any significant degree. When this is accomplished, optimum physical characteristics, including low water vapor transmission rates and a high degree of light scattering are obtained without void splitting or film fibrillating.

As indicated above, the matrix polymer and the void initiating particle must be incompatible and this term is used in the sense that the materials are two distinct phases. The spherical void initiating particles constitute a dispersed phase throughout the lower melting polymer which polymer will, ultimately, upon orientation, become a void-filled matrix with the spherical particles positioned somewhere in the voids.

As a result of the biaxial orientation of the film structure herein, in addition to opacifying the core layer 14 of the structure, the orientation improves other physical properties of the composite layers such as flex-crack resistance, Elmendorff tear strength, elongation, tensile strength, impact strength and cold strength properties. The resulting film can have, in addition to a rich high quality appearance and excellent opacifying characteristics, low water vapor transmission rate characteristics and low oxygen transmission rate characteristics. This makes the film ideally suited for packaging food products including liquids. The film also has attractive utility as a decorative wrap material.

It is believed that because of comparative sphericity of the void-initiating particles, the voids are closed cells. This means that there is virtually no path open from one side of the core to the other through which liquid or gas can transverse.

The polymers contemplated herein for the first skin layer 10, first transition layer 12, second transition layer 16 and second skin layer 18 can be selected from those polymers typically employed in the manufacture of multi-layered films.

Typical examples of materials which are suitable for use as the skin layers are coextrudable materials which form a seal upon application of elevated temperatures and, at least slight pressure. Examples of polymeric materials which can be used for the sealing layer include olefinic homo-, co- or terpolymers. The olefinic monomers can comprise 2 to 8 carbon atoms. Specific examples include polypropylene, ethylene-propylene random copolymer, ethylene-butene-1 copolymer, ethylene-propylene-butene-1 terpolymer, propylene-butene copolymer, high density polyethylene, low density polyethylene, linear low density polyethylene, very low density polyethylene, metallocene-catalyzed polyethylene, metallocene-catalyzed polymers known by the term plastomer, metallocene-catalyzed ethylene-hexene copolymer, metallocene-catalyzed ethylene-butene copolymer, metallocene-catalyzed ethylene-octene copolymer, ethylene-methacrylic acid copolymer, ethylene-vinyl acetate copolymer and ionomer resin. A blend of the foregoing materials is also contemplated such as a blend of the plastomer and ethylene-butene copolymer.

The core and transition layers of the present invention may be any one of the coextrudable, biaxially orientable film-forming resins known in the art. Such materials include, but are not limited to, isotactic polypropylene high density polyethylene, low density polyethylene, linear low density polyethylene, very low density polyethylene, metallocene-catalyzed polyethylene and polypropylene, metallocene-catalyzed polymers known by the terplastomer syndiotactic polypropylene, propylene copolymers and terpolymers which include other monomers such as ethylene and/or butene-1, ethylene copolymers and terpolymers which include other monomers such as propylene and/or butene-1. Typical copolymers are ethylene-propylene copolymers, ethylene-butene-1 copolymers, butene-1-propylene random copolymers, and ethylene-propylene block copolymers. Typical terpolymers are ethylene-propylene-butene-1 terpolymers. Alternative and useful thermoplastic materials include, but are not limited to nylon, polyester, ethylene-vinyl acetate copolymer, and ethylene-vinyl alcohol copolymer. Blends of any of the foregoing homopolymers, copolymers and terpolymers are contemplated. Ethylene-propylene-butene-1 random terpolymers appropriate for use in the core of the present invention include those containing 1-5 weight percent random ethylene and 10-25 weight percent random butene-1, with the balance being made up of propylene. The amounts of the random ethylene and butene-1 components in these terpolymers are typically in the range of 10 to 25 weight percent (ethylene plus butene-1) based on the total amount of the copolymer.

The copolymers and terpolymers typically have a melt flow rate in the range of about 1.5 to 15 g/10 min, with a density of about 0.9 and a melting point in the range of about 115 to about 170° C.

In one embodiment, the exposed first surface 11 and/or second surface 19 are treated in a known and conventional manner, e.g., by corona discharge to improve its receptivity to inks and/or its suitability for such subsequent manufacturing operations as lamination.

In one embodiment, the exposed treated or untreated first surface 11 and/or second surface 19 have applied to it, coating compositions or substrates such as another polymer film or laminate; a metal foil such as aluminum foil; cellulosic webs, e.g. numerous varieties of paper such as corrugated paperboard, craft paper, glassine, cartonboard; non- woven tissue, e.g., spunbonded polyolefin fiber, melt-blown microfibers, etc. The application may employ a suitable adhesive, e.g., a hot melt adhesive such as low density polyethylene, ethylene-methacrylate copolymer, water-based adhesive such as polyvinylidene chloride latex, and the like.

The film of the present invention may be laminated to another polyolefin film (eg: thermal, adhesive, extrusion, etc).

In one embodiment, the first skin layer 10, first transition layer 12, second transition layer 16, and second skin layer 18 includes up to about 90% by wt., in another embodiment from about 2% to about 20% by wt., and in a third embodiment from about 3% to about 10% by wt. of a coloring agent is used. U.S. Pat. Nos. 5,894,048; 4,894,264; 4,536,184; 5,683,805; 5,328,743; and 4,681,803 disclose the use of coloring agents, the disclosures of which are incorporated herein by reference in their entirety. Suitable coloring agents include pigments and dyes. In one embodiment, pigments and dyes include organic pigments and dyes such as phthalocyanine, azo, condensed azo, azo lake, anthraquinone, perylene/perinone, indigo/thioindigo, isoindolinone, azomethineazo, dioxazine, quinacridone, aniline black, triphenylmethane and carbon black pigments; and inorganic pigments and dyes such as titanium oxide, iron oxide, iron hydroxide, chrome oxide, spinel-form calcination type, chromic acid, chrome vermilion, iron blue, aluminum powder and bronze powder pigments. These pigments may be provided in any form or may be subjected in advance to various dispersion treatment in a manner known per se in the art. Depending on the material to be colored, the coloring agent can be added with one or more of various additives such as organic solvents, film-forming resins (in not a large proportion), flame retardants, antioxidants, ultraviolet absorbers, plasticizers and surfactants. Colored compounded thermoplastics which are commercially available are easier to use with this invention, although direction addition of a dye or pigment to the extrusion is possible. In another embodiment colored compounded thermoplastic concentrates are used. (For example from Schulman: Polybatch Blue P4021, Polybatch Blue P4535, Polybatch Red P50346, Polybatch Yellow P2214F, Polybatch Green P3510 F, Polybatch Brown P1028F, and Polybatch Orange P10307; from Ampacet: LR-92396 (blue), LR-92011 (blue), LR-92397 (green), LR-92398 (yellow), and LR-92010 (red); from Milliken Clear Tint Blue 9805, Clear Tint Red 9803, Clear Tint Amber 9808, and Clear Tint Green 9807.) In a third embodiment colored compounded thermoplastic concentrates contain lower amounts of titanium dioxide or are otherwise lower in opacity. Furthermore, a color on the first surface 11 or second surface 19 of the film allows printing of laminated or unlaminated structures without requiring a base colored ink.

The first skin layer 10 and/or the second skin layer 18 may be heat sealable or non heat sealable. In one embodiment, if the first skin layer 10 and/or the second skin layer 18 are not heat sealable, then a heat sealable layer (not shown) may be applied to the first skin layer 10 and/or the second skin layer 18. A heat sealable layer (not shown) may be, for example, vinylidene chloride polymer or an acrylic polymer; or heat sealable layer (not shown) may be coextruded from any of the heat sealable materials described for the first skin layer 10 and/or the second skin layer 18. Vinylidene chloride polymer or acrylic polymer coating may also be applied to the exposed first surface 11 or the second surface 19.

In another embodiment, if the first skin layer 10 and/or the second skin layer 18 are heat sealable, it can be fabricated from any of the heat sealable copolymers, blends of homopolymers and blends of copolymer(s) and homopolymer(s) heretofore employed for this purpose. Illustrative of heat sealable copolymers which can be used for the first skin layer 10 and/or the second skin layer 18 of the present film are ethylene-propylene copolymers containing from about 1.5 to about 12, and alternatively from about 3 to about 7 weight percent ethylene and ethylene- propylene-butene terpolymers containing from about 1 to about 10, and alternatively from about 1 to about 6 weight percent ethylene and from about 70 to about 97. In another embodiment, heat sealable blends of homopolymer can be utilized for the first skin layer 10 and/or the second skin layer 18 which include from about 1 to about 99 weight percent polypropylene homopolymer, e.g., one which is the same as, or different from, the polypropylene homopolymer constituting core layer 14 blended with from about 99 to about 1 weight percent of a linear low density polyethylene (LDPE). If the first skin layer 10 and/or the second skin layer 18 are heat-sealable, corona or flame treatment of that layer is optional.

In another embodiment, heat sealable blends of copolymer(s) and homopolymer(s) which may be used for the first skin layer 10 and/or the second skin layer 18 include: a blend of from about 5 to about 19 weight percent of polybutylene and from about 95 to about 81 weight percent of a copolymer of propylene (80 to about 95 mole percent) and butylene (20 to about 5 mole percent); a blend of from about 10 to about 90 weight percent of polybutylene and from about 90 to about 10 weight percent of a copolymer of ethylene (2 to about 49 mole percent) and a higher olefin having 4 or more carbon atoms (98 to about 51 mole percent); a blend of from about 10 to about 90 weight percent polybutylene and from about 90 to about 10 weight percent of a copolymer of ethylene (10 to about 97 mole percent) and propylene (90 to about 3 mole percent); and, a blend of from about 90 to about 10 weight percent of polybutylene, and from about 10 to about 90 weight percent of a copolymer of propylene (2 to about 79 mole percent) and butylene (98 to about 21 mole percent).

In one embodiment, the first skin layer 10, first transition layer 12, core layer 14, second transition layer 16, and second skin layer 18 are coextruded. Thereafter, the film is preferably biaxially oriented. For example, when employing polypropylene for the core matrix and the skin layers and employing PBT as the void initiating particles, a machine direction orientation is preferably from about 4 to about 8 and a transverse orientation is preferably from 4 to about 10 times at a drawing temperature of about 100 degrees C. to 170 degrees C. to yield a biaxially oriented film. A preferred film thickness is from about 0.5 mil to about 3.5 mils.

Although various embodiments have been disclosed for the five layer film 50, three layer film 30, four layer film 40, and two layer film 20, additional embodiments of films with two or more layers are possible by interchanging elements of coloring agents, printing, and inorganic and organic additives that would be clear to one with ordinary skill in the art.

In another embodiment the first skin layer 10 and/or the second skin layer 18 has a coating or metal layer applied. U.S. Pat. Nos. 6,077,602; 6,013,353; 5,981,079; 5,972,496; 6,074,762; 6,025,059; and 5,888,648 disclose the use of coatings and/or metal layers on a film, and are disclosed herein by reference. In one embodiment, suitable coatings may include PVdC's or acrylics which serve to boost gloss, enhance machineability, and/or enhance ink adhesion; suitable metals may include aluminum.

The following examples illustrate the present invention:

### EXAMPLE 1

Samples were produced having the following structure:

| | |
|---|---|
| | Corona Treatment |
| L1 | EP impact copolymer |
| L2 | Homopolymer PP or Terpolymer with color concentrate |
| L3 | Homopolymer core (+ cavitating agent) |
| L4 | Homopolymer PP or Terpolymer with opacifier |
| L5 | EP impact copolymer |
| | Corona Treatment |

Thickness of the uncavitated film was 0.80 mils.

The following materials were run using this structure:

| | | Skin | | | | | | |
|---|---|---|---|---|---|---|---|---|
| | | L1 | | | | | | |
| | | and | | | | | | |
| | | L5 | | L4 | | | L2 | |
| | L1 and L5 | thick | | thick | | | thick | |
| Run | Resin | (ga) | Layer 4 resin | (ga) | | Layer 2 resin | (ga) | |
| 1 | Montell 8523 | 0.5 | Fina 3371 w/40% | 8 | ga | Fina 3371 w/30% | 4 | ga |
| | | | Schulman CTW5050 | | | Schulman P10204/5 | | |
| 2 | Montell 8523 | 0.5 | Chisso XPM7880 | 8 | ga | Chisso XPM7800 | 4 | ga |
| | | | w/40% Schulman | | | w/30% Schulman | | |
| | | | P8555-SC | | | P10204/5 | | |

Before producing sample 3 and 4 - add 8% Ticona Celenex 1300A PBT to the core

| | | | | | | | | |
|---|---|---|---|---|---|---|---|---|
| 3 | Montell 8523 | 0.5 | Chisso XPM7880 | 8 | ga | Chisso XPM7800 | 4 | ga |
| | | | w/40% Schulman | | | w/30% Schulman | | |
| | | | P8555-SC | | | P10204/5 | | |
| 4 | Montell 8523 | 0.5 | Fina 3371 w/40% | 8 | ga | Fina 3371 w/30% | 4 | ga |
| | | | Schulman CTW5050 | | | Schulman P10204/5 | | |

Material Descriptions:
Montell 8523 is an EP impact copolymer
Schulman P8555-SC (50% TiO2 in EP random copolymer (Fina 8573))
Schulman CTW5050 referred above is 50% TiO2 (Millenium RCL4) in PP homopolymer
Schulman P10204/5 is a brown masterbatch containing a total of 35% pigment (iron oxide, carbon black, TiO2) in PP homopolymer.
Chisso XPM7880 is an EPB terpolymer
Fina 3371 is a 3 MF PP homopolymer

The films produced during the experiment had the brown and white kraft paper of color and fiber-like appearance to them.

### EXAMPLE 2

A second set of runs was made having the following structure:

| | |
|---|---|
| | Corona Treatment |
| L1 | Propylene or ethylene copolymers + additives |
| L2 | Homopolymer with color concentrate |
| L3 | Homopolymer core + cavitating agent |
| L4 | Homopolymer with opacifier |
| L5 | Propylene or ethylene copolymers + additives |
| | Corona Treatment |

The core homopolymer was cavitated in all cases.

| | | Skin | | | | | | | |
|---|---|---|---|---|---|---|---|---|---|
| | | L1 | | | | | | | |
| | | and | | | | | | | |
| | Skin Resin | L5 | | | L4 | | | L2 | |
| | (L1 & L5 | thick | | | thick | | | thick | |
| Run | layers) | (ga) | | Layer 4 resin | (ga) | | Layer 2 resin | (ga) | |
| 5 | Montell 8523 + | 6 | ga | Chisso XPM7880 | 8 | ga | Chisso XPM 7800 | 5-8 | ga |
| | 16% Schulman | | | w/40% Schulman | | | w/30% Schulman | | |
| | T4448/50 | | | CTW50/50 | | | P10204/5 | | |
| 6 | Montell 8523 | 1 | ga | Chisso XPM7880 + | 8 | ga | Chisso XPM7880 + | 5 | ga |
| | | | | 20% T4448/5 + 40% | | | 20% T4448/5 + | | |
| | | | | CTW5050 | | | 30% P10204/5 | | |

Material Description:
Schulman Papermatch T4448/50 (HW HDPE w/high CaCO3 loading and TiO2)

Properties of the films produced in Examples 1 and 2 are given in Table 1.

TABLE 1

| | | | | | | | Gloss | Gloss | COF | COF |
|---|---|---|---|---|---|---|---|---|---|---|
| | | | Optical | | Treatment | | Brown | White | Brown | white |
| Sample | Skins | Core | Gauge | Yield | Both sides | | side | side | side | side |
| | | | | | | Haze | | | | |
| 1 | Brown/white | Clear | 75.6 | 40400 | 38 | 49.4 | 30.7 | 33.4 | 0.421 | 0.430 |
| 2 | Brown/white | Clear | 80.9 | 37800 | 37 | 48.6 | 33.5 | 34.5 | 0.671 | 0.765 |
| 3 | Brown/white | Cavitated | 110.7 | 37200 | 36 | 29.2 | 35.9 | 36.4 | 0.619 | 0.765 |
| 4 | Brown/white | Cavitated | 109 | 38200 | 37 | 27.1 | 30.8 | 36.6 | 0.421 | 0.430 |
| | | | | | | Light | | | | |
| | | | | | | Trans % | | | | |
| 5 | White matte/ | PP | 99 | 37177 | 39 | 31 | 13.4 | 15.1 | 0.28 | 0.27 |
| | tan matte | (cavitated) | | | | | | | | |
| | (uniform | | | | | | | | | |
| | surface look) | | | | | | | | | |
| 6 | White matte/ | PP | 96 | 38845 | 37 | 30.4 | 28.1 | 25.3 | 0.32 | 0.33 |
| | tan matte | Cavitated | | | | | | | | |
| | (fiber-like | | | | | | | | | |
| | surface look) | | | | | | | | | |

| | | |
|---|---|---|
| Brown kraft paper bag | 5.1 | |
| White bleached paper | | 5 |
| bag | | |

The films of Example 2, produced during the second experiment had the brown and white paper type of color and also lower gloss and a rougher surface finish to more closely resemble the look and texture of kraft paper. Sample 5 had a uniform type of surface appearance, whereas Sample 7 was produced with a non-uniform “fiber-like” surface appearance that more closely resembles the “fiber-like” look of kraft paper. All these films are surface printable on either the white kraft or brown kraft side. The side opposite the print side is also surface treated and hence suitable for either adhesive or extrusion lamination to a high barrier clear or high barrier metallized film.

### EXAMPLE 3

A third set of samples was produced to evaluate color concentrates for potential use in flex-pack applications, using the following structure:

| | | |
|---|---|---|
| L1 | 3 ga. | Dow Dowlex 2027A MDPE |
| L2 | 14 or 27 ga. | Exxon 4612 Homopolymer PP + color concentrate (see |
| | | Table 2) |
| L3 | 40 or 53 ga. | Exxon 4612 Homopolymer PP + Celanese 1300A |
| | | cavitating agent |
| L4 | 27 ga. | Exxon 4612 Homopolymer PP |
| L5 | 3 ga. | Exxon 4612 Homopolymer PP |
| | | Corona Treatment |

The films had a thickness of ±1.4 mils when cavitated, and a polymer thickness equivalent to ±1.0 mils if no cavitation had occurred. The core layer thickness, L3, shown above is based on the thickness that would be obtained if the film were not cavitated. The color concentrates were run at a 2:1 let down ratio.

Color concentrates used, colored layer thicknesses, color measurements, using a HunterLab UltraScan XE, and gloss measurements are summarized in Table 2 and 15 Table 3.

TABLE 2

| | L2 | L3 | | | | | |
|---|---|---|---|---|---|---|---|
| Sample | Thickness | Thickness | Color mater batch used in L2 | a* | b* | L* | Opacity |
| 8 | 27 ga. | 40 ga. | Ampacet LR-92010 (flex-pack red) | 46.79 | −8.39 | 56.04 | 67.76 |
| 9 | 14 ga. | 53 ga. | Ampacet LR-92010 (flex-pack red) | 44.48 | −9.73 | 59.69 | 70.80 |
| 10 | 27 ga. | 40 ga. | Ampacet LR-92011 (flex-pack blue) | −17.12 | −40.60 | 46.13 | 66.38 |
| 11 | 14 ga. | 53 ga. | Ampacet LR-92011 (flex-pack blue) | −24.70 | −40.51 | 54.52 | 73.37 |

TABLE 3

| | | | Gloss at Different Angles of Incident Light | | | |
|---|---|---|---|---|---|---|
| Sample | Film Type | Color | 20° | 45° | 60° | 85° |
| 8 | Cavitated White | Dark Red | 43.1 | 63.0 | 87.4 | 97.6 |
| 9 | Cavitated White | Light Red | 39.9 | 68.4 | 88.8 | 97.2 |
| 10 | Cavitated White | Dark Blue | 44.1 | 53.9 | 85.2 | 97.9 |
| 11 | Cavitated White | Light Blue | 38.2 | 54.5 | 83.1 | 97.3 |
| Reference | Non-cavitated White | Solid White | 33.0 | 30.0 | 51.4 | 93.7 |
| Reference | Clear | No color | 104.8 | 85.3 | 130.4 | 104.2 |

[image]

### EXAMPLE 4

A fourth set of runs was made having the following structure:

| | |
|---|---|
| L1 | 3 ga. terpolymer sealant |
| L2 | ±20 ga. homopolymer (+ color concentrate) |
| L3 | ±54 ga. homopolymer + 6% cavitating agent |
| L4 | 20 ga. homopolymer (+ opacifier) |
| L5 | 3 ga. terpolymer sealant |

The colorant was located in a relatively thin tie layer sandwiched between a clear skin and a white, cavitated core. In some cases, the thickness of L2 was doubled. In some other cases, L2 was made half as thick. To maintain a constant film thickness, the difference in thickness was made up by changing the core thickness to compensate for the thicker or thinner L2.

| | % Loading | | | | | | | | L2 Thickness |
|---|---|---|---|---|---|---|---|---|---|
| Schulman | | | | | | | | | |
| Polybatch | | | 10 | | | 25 | | | Normal |
| Blue P4021 | | | 10 | | | | | | ½× normal |
| | | | 10 | | | | | | 2× normal |
| Polybatch | 5 | 8 | | 15 | | 25 | | | Normal |
| Red P50346 | | | | | | | | | |
| Polybatch | 5 | | 10 | | 22 | | | | normal |
| Yellow P2214F | | | | | | | | | |
| Polybatch | 5 | | 10 | | | 25 | 50 | 75 | Normal |
| Green 3510F | | | | | | | | | |
| Polybatch | 5 | | 10 | | | 25 | 50 | 75 | Normal |
| Brown P1028F | | | | | | | | | |
| Ampacet | | | | | | | | | |
| LR-92396 | | | 10 | | | 25 | 50 | 75 | Normal |
| (blue) | | | | | | | | | |
| LR-92397 | | | 10 | | | 25 | 50 | 75 | Normal |
| (green) | | | | | | | | | |
| LR-92398 | | | | | 21 | | 50 | 75 | Normal |
| (yellow) | | | | | | | | | |

The a*, b* and L* values for all of these films have been measured along with all their light transmission and gloss values. The data are given in Table 3.

TABLE 3

| | L2 layer gauge | a* | b* | L* | Gloss | LT |
|---|---|---|---|---|---|---|
| 10% Polybatch Blue P4021/90% 4612E2 | Normal | −14.51 | −24.89 | 78.03 | 67 | 27.2 |
| 10% Polybatch Blue P4021/90% 4612E2 | 0.5× normal | −7.61 | −12.34 | 87.32 | 71.5 | 29.6 |
| 10% Polybatch Blue P4021/90% 4612E2 | 2× normal | −17.91 | −32.67 | 71.48 | 65.4 | 25.3 |
| 25% Polybatch Blue P4021/90% 4612E2 | Normal | −17.07 | −39.64 | 63.68 | 48.9 | 18.5 |
| 5% Polybatch Red P50346/95% Exxon 4612E2 | Normal | 23.56 | 6.84 | 68.81 | 72.6 | 26 |
| 8% Polybatch Red P50346/92% Exxon 4612E2 | Normal | 33.78 | 11.93 | 61.87 | 63.4 | 21.4 |
| 15% Polybatch Red P50346/85% Exxon 4612E2 | Normal | 44.65 | 51.52 | 53.36 | 51 | 13.4 |
| 25% Polybatch Red P50346/75% Exxon 4612E2 | Normal | 47.49 | 27.47 | 49.01 | 41.8 | 6.8 |
| 5% Polybatch Yellow P2214F/95% Exxon 4612E2 | Normal | −3.3 | 22.52 | 83.72 | 78.3 | 33.9 |
| 10% Polybatch Yellow P2214F/90% Exxon 4612E2 | Normal | −0.27 | 0.69 | 86.47 | 68.1 | 31 |
| 22% Polybatch Yellow P2214F/78% Exxon 4612E2 | Normal | 0.28 | 60.33 | 82.63 | 54 | 25 |
| 5% Polybatch Green P3510F/95% Exxon 4612E2 | Normal | −13.19 | 14.83 | 82.2 | 79.3 | 27.5 |
| 10% Polybatch Green P3510F/90% Exxon 4612E2 | Normal | −20.48 | 22.8 | 77.22 | 69 | 28 |
| 25% Polybatch Green P3510F/75% Exxon 4612E2 | Normal | −33.32 | 34.53 | 66.46 | 45.5 | 18.6 |
| 50% Polybatch Green P3510F/50% Exxon 4612E2 | Normal | −35.4 | 31.82 | 59.07 | 31.6 | 12.6 |
| 75% Polybatch Green P3510F/25% Exxon 4612E2 | Normal | −32.77 | 27.03 | 54.91 | 15 | 7.3 |
| 5% Polybatch Brown P1028F/95% Exxon 4612E2 | Normal | 4.93 | 8.08 | 67.3 | 66 | 22.4 |
| 10% Polybatch Brown P1028F/90% Exxon 4612E2 | Normal | 8.06 | 11.02 | 54.19 | 52.8 | 15.1 |
| 25% Polybatch Brown P1028F/75% Exxon 4612E2 | Normal | 6.83 | 7.37 | 35.96 | 35.5 | 3.9 |
| 50% Polybatch Brown P1028F/50% Exxon 4612E2 | Normal | 5.5 | 5.98 | 33.28 | 26 | 0.2 |
| 75% Polybatch Brown P1028F/25% Exxon 4612E2 | Normal | 5.27 | 5.41 | 31.88 | 23.4 | 0 |
| 10% LR-92396 (blue)/90% Exxon 4612E2 | Normal | −33.83 | −28.49 | 75.83 | 64.8 | 24.3 |
| 25% LR-92396 (blue)/75% Exxon 4612E2 | Normal | −38.62 | −40.05 | 64.69 | 58.6 | 23.6 |
| 50% LR-92396 (blue)/50% Exxon 4612E2 | Normal | −32.18 | −44.93 | 57.05 | 46.6 | 9.5 |
| 75% LR-92396 (blue)/25% Exxon 4612E2 | Normal | −27.39 | −45.34 | 52.96 | 40.2 | 7.7 |
| 10% LR-92397 (green)/90% Exxon 4612E2 | Normal | −24.49 | −1.21 | 87.92 | 80.6 | 28.9 |
| 25% LR-92397 (green)/75% Exxon 4612E2 | Normal | −42.73 | 0.22 | 82.27 | 68.5 | 25.9 |
| 50% LR-92397 (green)/50% Exxon 4612E2 | Normal | −58.37 | 3.74 | 76.72 | 59.5 | 22.4 |
| 75% LR-92397 (green)/25% Exxon 4612E2 | Normal | −66.93 | 7.18 | 72.55 | 46.8 | 21.4 |
| 21% LR-92398 (yellow)/79% Exxon 4612E2 | Normal | −9 | 40.35 | 93.18 | 89.7 | 31.7 |
| 50% LR-92398 (yellow)/50% Exxon 4612E2 | Normal | −9.93 | 67.02 | 91.65 | 75.2 | 29.7 |
| 75% LR-92398 (yellow)/25% Exxon 4612E2 | Normal | −8.32 | 80.86 | 90.59 | 61.5 | 29.8 |
| | | * | * | * | * | * |
| 10% Polybatch Blue P4021/90% 4612 E2 + | Normal | −0.39 | −14.55 | 65.12 | 44.9 | 12.4 |
| 10% Polybatch Red P50346/90% 4612E2 | Normal | 44.75 | 21.9 | 49.02 | 52.5 | * |

For the last entry in Table 3, a blue colorant was coextruded in L2 with a red colorant in L4. There was very little influence of the color on either side affecting the color on the other side.

Those films that were made in such a manner that much of the incident light on the film surface passed into the film, reflected off the cavitated core surface, and passed back through the entry surface had a very vibrant, deep appearing look to them. Many of the films that have been produced have a more “vibrant” appearance than do some of the others. The color concentrates that contain lower amounts of titanium dioxide or are otherwise lower in opacity correlate to this aesthetic preference

### Example 5

In a fifth experimental run, L2 of Example 4 was set up to consist of two separate coextruded layers. Red color concentrate was fed into one layer and blue was fed into the other. A purple color was produced.

### Example 6

In a sixth experimental run, the following film structure was set up:

| | | |
|---|---|---|
| | | Corona Treatment |
| L1 | 10 ga. | MDPE (+ color concentrate) |
| L2 | 112 ga. | HDPE + CaCO₃ |
| L3 | 8 ga. | MDPE |
| | | Corona Treatment |

A yellow color concentrate, Polybatch Yellow P20287, purchased from A. Schulman, Inc., was introduced into the L1 layer at 10%. An aesthetically pleasing film, yellow on one side and white on the other was obtained.

We claim:

1. A multi-layered colored polymeric film comprising:
(a) an opaque core layer comprising a thermoplastic material having a first side and a second side;
(b) a first skin layer comprising a thermoplastic material with a coloring agent wherein said skin layer is adjacent to the first side of the core layer.

2. The film of claim 1 wherein the core layer comprises a stratum of voids; positioned at least substantially within at least a substantial number of each of said voids, is at least one spherical void-initiating particle which is phase distinct and incompatible with said matrix material, the void space occupied by said particle being substantially less than the volume of said void, with one generally cross-sectional dimension of said particle at least approximating a corresponding cross-sectional dimension of said void.

3. The film of claim 1 wherein the core layer comprises from about 1.5% to about 15% by weight of TiO₂.

4. The film of claim 2 wherein the core layer comprises from about 1.5% to about 15% by weight of TiO₂.

5. The film of claim 2 wherein the core layer comprises isotactic polypropylene.

6. The film of claim 2 wherein the core layer comprises void-initiating particles of polybutylene terephthalate.

7. The film of claim 4 wherein the core layer comprises void-initiating particles of polybutylene terephthalate.

8. A multi-layered colored thermoplastic film comprising:
(a) an opaque core layer comprising a thermoplastic material having a first side and a second side;
(b) a first transition layer comprising a thermoplastic material having a first side and a second side wherein the first transition layer comprises a coloring agent and the second side of the transition layer is adjacent to the first side of the core layer;
(c) a first skin layer comprising a thermoplastic material having a first side and a second side wherein the second side of the skin layer is adjacent to the first side of the first transition layer.

9. The film of claim 8 further comprising a second skin layer having a first side and a second side wherein the first side of the second skin layer is adjacent to the second side of the core layer.

10. The film of claim 8 further comprising a second transition layer having a first side and a second side wherein the first side of the second transition layer is adjacent to the second side of the core layer and a second skin layer having a first side and a second side wherein the first side of the second skin layer is adjacent to the second side of the second transition layer.

11. The film of claim 8 wherein the core layer comprises a stratum of voids; positioned at least substantially within at least a substantial number of each of said voids, is at least one spherical void-initiating particle which is phase distinct and incompatible with said matrix material, the void space occupied by said particle being substantially less than the volume of said void, with one generally cross-sectional dimension of said particle at least approximating a corresponding cross-sectional dimension of said void.

12. The film of claim 11 wherein the core layer comprises void-initiating particles of polybutylene terephthalate.

13. The film of claim 12 wherein the first skin layer is substantially transparent and an image is printed on the first side of the first skin layer.

14. The film of claim 12 wherein the first skin layer comprises inorganic additives.

15. The film of claim 14 wherein the inorganic additives in the first skin layer is a material selected from the group consisting of calcium carbonate, titanium dioxide, talc, and silica.

16. The film of claim 12 further comprising inorganic additives in the first transition layer selected from the group consisting of calcium carbonate, titanium dioxide, talc, and silica.

17. The film of claim 10 wherein the core layer comprises a strata of voids; positioned at least substantially within at least a substantial number of each of said voids, is at least one spherical void-initiating particle which is phase distinct and incompatible with said matrix material, the void space occupied by said particle being substantially less than the volume of said void, with one generally cross-sectional dimension of said particle at least approximating a corresponding cross-sectional dimension of said void.

18. The film of claim 17 wherein the core layer comprises void-initiating particles of polybutylene terephthalate.

19. The film of claim 18 wherein the first skin layer is substantially transparent and an image is printed on the first side of the first skin layer.

20. The film of claim 19 wherein the second skin layer is substantially transparent and an image is printed on the second side of the second skin layer.

21. The film of claim 18 further comprising inorganic additives in the first skin layer selected from the group consisting of calcium carbonate, titanium dioxide, talc, and silica.

22. The film of claim 21 further comprising inorganic additives in the second skin layer selected from the group consisting of calcium carbonate, titanium dioxide, talc, and silica.

23. The film of claim 22 wherein the first transition layer is brown and the second transition layer is white.

24. The film of claim 10 further comprising a coloring agent in the second transition layer.

25. The film of claim 17 further comprising a coloring agent in the second transition layer.

26. The film of claim 18 further comprising a coloring agent in the second transition layer.

27. A method of producing a multi-layered colored thermoplastic film comprising the steps of:
(a) coextruding a first skin layer comprising a thermoplastic material with a coloring agent adjacent to an opaque core layer made of a thermoplastic material;
(b) orienting said first skin layer and said opaque core layer in the machine direction at an elevated temperature;
(c) orienting said first skin layer and opaque core layer in the transverse direction at an elevated temperature.

28. A multi-layered thermoplastic film comprising a first skin layer made of a thermoplastic material and an opaque core layer made of a thermoplastic material wherein the improvement comprises:
(a) coloring agent in the first skin layer.

29. The film of claim 2 wherein the core layer comprises a material selected from the group consisting of high density polyethylene and linear low density polyethylene.

30. The film of claim 29 wherein the core layer comprises calcium carbonate.

31. A multi-layered colored thermoplastic film comprising:
(a) an opaque core layer comprising a thermoplastic material having a first side and a second side;
(b) a first transition layer comprising a thermoplastic material having a first side and a second side wherein the second side of the transition layer is adjacent to the first side of the core layer;
(c) a first skin layer comprising a thermoplastic material having a first side and a second side wherein the first skin layer comprises a coloring agent and the second side of the first skin layer is adjacent to the first side of the first transition layer.

32. The film of claim 31 further comprising a second skin layer having a first side and a second side wherein the first side of the second skin layer is adjacent to the second side of the core layer.

33. The film of claim 31 further comprising a second transition layer having a first side and a second side wherein the first side of the second transition layer is adjacent to the second side of the core layer and a second skin layer having a first side and a second side wherein the first side of the second skin layer is adjacent to the second side of the second transition layer.

34. The film of claim 32 wherein the second skin layer comprises a coloring agent.

35. The film of claim 33 wherein the second skin layer comprises a coloring agent.

36. The film of claim 1 wherein the first skin layer has a percent opacity less than about 40% and a percent light transmission greater than about 65%.

37. The film of claim 8 wherein the combination of the first skin layer and the first transition layer has a percent opacity less than about 40% and a percent light transmission greater than about 65%.
